(19) United States
(12) Patent Application Publication
(10) Pub. No.: US 2006/0218020 A1
(43) Pub. Date: Sep. 28, 2006

(54) Products and services insurance security method, product and system, and method of conducting business

(76) Inventors: Jeffery Moore, Seattle, WA (US); Ian Eisenberg, Seattle, WA (US)

Correspondence Address: John P. Luther;Newman & Newman LLP, Suite 610, 505 Fifth Avenue South, Seattle, WA, 98104, US

(21) Appl. No.: 11/090,736

(22) Filed: Mar. 25, 2005

(51) Int. Cl. G06Q 40/00; G06Q 99/00

(52) U.S. Cl. 705/4; 705/1

(57) ABSTRACT

The present invention provides a method, product and system for insuring the cost and/or replacement of goods and/or services purchased and/or acquired by way of wireline or wireless telephone devices, or through an Internet web site, and for use of said goods and/or services in or with said telephone devices.

### FIELD OF INVENTION

The present invention relates to an insurance method, product and system by which a user or owner of a phone device may acquire insurance against the loss of various personal property, such as information, products and/or services which have been purchased and/or acquired and stored in the user's personal mobile phone device, such as a cellular telephone.

### COPYRIGHT NOTICE

Copyright 2005 Blue Frog Mobile, Inc. All rights reserved. A portion of the disclosure of this patent application/patent disclosure and/or document contains material which is subject to copyright protection. The copyright owner has no objection to the facsimile reproduction by anyone of the patent document or the patent disclosure as it appears in the United States Patent and Trademark Office files and records.

### BACKGROUND OF THE INVENTION

Cellular telephones and the use of wireless technology in general have seen a huge upsurge in use and popularity in recent years. Along with such increase intense competition between the several market entries has developed in conjunction with a number of new and useful, and highly interesting functional features for mobile phone devices and carriers.

Many of such features which add to the enjoyment of using mobile phone devices are built into respective units, and which may include e-mail capability, mini-computing and the like. On a more whimsical side, but oftentimes equally important in the enjoyment of mobile phone usage, are those personal touches wherein one may customize the look and sound of their phone, or perhaps include their favorite games in their personal phone's capability or storage. Thus, an entire industry has evolved in which one may purchase a customized ringtone for their personal mobile phone, or a “wallpaper” design for their phone's display, or even an assortment of games which may be downloaded into one's phone or access permitted to various of match making and dating services and other services such as providing sports score information, financial and news reports, stocks and company performance information and the like. Such items may, for example, be purchased or ordered on a pre-paid basis and downloaded into one's phone from a number of sources for use during various periods of time.

However, once a phone is replaced, or perhaps lost or stolen, such purchased cellular products and services are lost along with the phone and other valuable contract information, such as stored personal information, data and coded information. Additionally, telephones are routinely changed from time to time, such as when one upgrades to a newer model which may be more compact or of higher functionality. Phones may be also replaced when users change service carriers. While some currently available phone service carriers and/or cellular telephones may include complex backup procedures which allow a limited amount of backup information to be stored, for example, as a list on a personal computer and the like, such systems cannot replace or restore a lost connection to pre-paid service lines which can only be reactivated by additional fee payment and programming.

As such, it would be highly beneficial to provide a backup method or system which would insure a phone owner or user against loss of purchased phone features and items.

### SUMMARY OF THE INVENTION

In accordance with that above the present invention provides a mobile phone device insurance method, product and system, in which a user and/or mobile phone device owner may optionally purchase, or otherwise be made available to acquire, insurance to cover the loss in value or replacement of pre-paid or purchased service features and items which may be irretrievably lost or disabled upon a user's change or replacement, or even repair, or a mobile phone device.

The present invention also provides for the operation or conducting of one or more of an array of business functions comprising the use of the inventive method and system.

The invention will be more fully understood with reference to the following Detailed Discussion of Preferred Embodiments.

### DETAILED DISCUSSION OF PREFERRED EMBODIMENTS

All patent reference published patent applications and literature references referred to or cited herein are expressly incorporated by reference herein to the same extent as if each were specifically and individually indicated to be incorporated by reference. Any inconsistency between these publications and the patent disclosure is intended to and shall be resolved in favor of the present disclosure.

In its broadest sense, the present invention provides a mobile phone device user and/or owner with the option of acquiring insurance to cover the cost or replacement of various service features and items bought and paid for, or otherwise acquired, for use with a particular mobile phone device, such as a cellular telephone, and which cannot be transferred to a new or replacement phone. As in any insurance program or product, the inventive method may be implemented upon a user's purchase or acquiring of various pre-paid phone services or items, for example, service contract services and products, such as access to chat lines or dating service lines, sports betting and/or lottery information, or products and games, such as interactive sports, custom ringtones and wallpaper displays, or any other service, such as access to professional services, business and financial counseling and the like. In other embodiments insurance may be purchased or provided, such as by contractual means or as a gift at any time prior to, during, or after the installation and/or acquiring for use with one's phone device goods and/or services. Insurance may be paid for or acquired for any period of time desired and costs therefor paid on any basis, such as a time basis by the month or pre-paid entirely on an up-front basis or according to a pro-rated schedule and the like, such as implemented in any conventional insurance agreement. In other embodiments insurance may at times be provided free of charge by a vendor or service provider, such as a value added incentive to purchase goods and/or products or even a certain phone device. Claims for losses may be implemented such as in any conventional insurance policy. The insurance services and product of the invention may also cover only the replacement of lost products and/or services rather than the cost or value of such or visa-versa, or may, for instance, cover only a fraction of the initial cost or value as prorated by time of use and the like, or may cover only the cost or replacement of selected goods and services for a certain time period, again perhaps as prorated in comparison to initial use. Additionally, in similar manner to any conventional insurance contract or binder or insurance method or product, the replacement or award of cost or value for lost products and services may be denied, for example, in the case of intentional destruction of one's phone, or by breaking a contingency in phone brand selection, or improper use of services and goods, or whatever is delineated in the terms of an insurance service contract. Insurance agreements may be provided by mail or by any other method of transmission.

Many brands of mobile phone devices, such as cellular phones in particular, may accommodate custom ringtones, such as, for instance, Nokia, Siemens, Samsung, with each company usually providing its own system for changing the ring tones. Some companies have capability which allows a cell phone owner to use a web-based composer to design ringing tones or themes, and then to manually input such customized ringtone into their phone. Other companies, such as Ericsson, provide their own melodies on their Internet web page and allow a user to pick and choose, and then input the desired content on their phone. In any event, a large portion of personal cellular phones may be enabled to employ customized ringtone capability and other services and products by receiving, for example, a type of Short Message Service (SMS) message, called a “Smart Message”, or other message which contains a ringtone of choice, or enables access to other products or services. Smart Messaging is a special type of text message which uses specialized codes to the attention of a user, and enables a functional message that is treated as a ringtone or, for instance, a screen logo, or other important information such as business cards or graphics which may identify a caller. Usually a fee is paid for changing one's ringtone, or for access to such products and services. The acquisition of, or access to, products and services, such as wallpaper themes and designs, chat lines and dating services, or games and the like may also proceed through this route.

In some instances, one may transfer services and products onto a personal cellular phone from a computer. By this method, a further investment is required in addition to paying a fee for services and products, by way of the need for equipment to connect the phone to a computer, such as a dedicated data cable. Additional specialized software may also be needed, such as Nokia Data Suite.

The present invention is also applicable for insuring products and services acquired or received by way of Multimedia Messaging (“MMS”) systems and procedures. As known, MMS as used in mobile communications networks denotes the latest approach for transmitting messages having a multimedia content and is oftentimes described as the most recent extension of SMS and EMS messaging protocol. MMS messaging allows messaging between different mobile users and/or between mobile users and the Internet via an e-mail address. Unlike SMS messaging, MMS can include not just text, but also sounds, images, video, animation and graphics. Formats that can be embedded with MMS include text formatted with fonts, colors, and the like, images (JPEG, GIG format and animator GLF), audio (MP3, WAV, AMR, MIPI) and video (WPEG and Real Media) and various combinations thereof. Images may be downloaded from WAP sites, for example, as selected from a menu within a phone.

The present invention also contemplates the employ of Enhanced Messaging Service “(EMS”), a type of halfway service between SMS and MMS which enables some features of MMS capability, such as text, some simple pictures and audio, and some simple graphics and animation.

Any conventional, or non-conventional, mobile phone device or the equivalent thereof is also contemplated for use in the inventive method and system, including cell phones from any catalog of the many mobile phone device vendors, some of which have the capability and appearance of a personal computer, or which are generally multifunctional, and which are preferably SMS and/or MMS capable. The inventive method is also contemplated for use with any mobile communication network. A mobile phone device for use with this invention may be Internet-enabled to download products and services purchased from a service provider. As discussed above, other mobile phone devices contemplated for use which may receive purchased products and/or services by receiving, for example, an SMS “Smart Message”, or other message which contains a product and/or service access for installation in a person's cellular phone, such as a customized ringtone, wallpaper, games, chat line access, news line access and the like, or mobile phone devices which are equipped with a Melody Composer, for example, for accepting programmable ringtones, or mobile phones equipped with infrared communications (Irda), such as the Nokia brand of cellular phones.

The vending and purchase of any goods and services which can be bought and sold over the telephone are contemplated for use in conjunction with the present inventive insurance method and system, and includes any service that can be conducted over telephone lines, such as a dedicated or public telephone system or a wireless telephone system or operation by way of WAP sites, with some non-limiting examples including for, illustration purposes only, dating services, match-making services, chat services, adult content services, technical support or know-how services, language learning, tutoring or other educational services involving a virtually limitless array of subject matter and topics. Further illustrative examples of services offered, bought and sold and covered by insurance via the present inventive method and system can include any type of professional service, such as legal services, medical services, psychiatric or psychological services, marriage counseling services and counseling services in general. Additional examples of services include gaming, gambling and handicapping services, architectural, business, and accounting services, and really anything or any type of information that can be provided and/or sold for a fee.

Some non-limiting examples of goods and/or related services for which insurance products and services may be purchased or otherwise acquired or provided via the present invention include games, interactive sports gaming, phone ringtones, wallpaper for cellular phone displays, music, movies, and computer software and all executable products, financial products, application products, design and engineering products, drawing and architectural products and any and all search products including personal histories, genealogies, criminal histories, automotive and other product histories, business histories and the like. In short, a description of services and goods covered by insurance in accordance with the present invention can only be limited by one's imagination.

It is also contemplated that the present invention be used in conjunction with such SMS and MMS methods as, for example, World-Text Two-Way SMS services which allow for sending and receiving SMS messages to and from an application or a person's e-mail, and the transmission of graphics and/or picture images via SMS messaging and the like.

Further contemplated for use herein are any and all network systems and computer software and hardware for carrying out the operational aspects and embodiments of the invention.

It will also be appreciated by those skilled in the art that the present inventive insurance method and system affords distinct business advantages not previously available to vendors relating to the telephonic sale and transfer of goods and/or services and relate information. In this aspect the present invention provides novel methods of conducting an array of business functions comprising designing, manufacturing, using, marketing, selling, licensing, and/or leasing the inventive subject matter, of developing business good will, and further providing novel methods of business entity formation, such as partnerships and corporations for conducting the business of the invention.

While the invention has been described in connection with what is presently considered to be the most practical and preferred embodiments, it is to be understood that this invention is not to be limited to the disclosed embodiments in any way which are merely set forth for illustrative purposes; to the contrary the present inventive method and system, and method for conducting business in general, is intended to cover an array of various modifications and equivalent arrangements, all of which are contemplated for inclusion within the spirit and scope of the disclosure and appended claims.

We claim:

1. A method for insuring the cost and/or replacement of goods and/or services purchased and/or acquired by way of a wireline or wireless phone device, or through an Internet web site, and installed for use in or with said phone device.

2. The method of claim 1 wherein said goods and/or services are purchased or acquired and installed by way off an SMS message, EMS message, an MMS message, an Internet web site or infrared communication.

3. The method of claim 1 wherein said service is a dating service, matchmaking service, chat service, adult content service, technical support or know-how service, language learning service, tutoring or educational service, legal service, medical service, psychiatric or psychological service, marriage counseling service, gaming and handicapping services, architectural services, business and/or accounting services, news reporting services, financial and/or tax services, weather reporting services, antique and/or appraisal services, credit reporting services, real estate services, court reporting services, and regulatory services.

4. The method of claim 1 wherein said goods are selected from games, interactive sports gaming, phone ring tones, wallpaper for cellular phone displays, music, movies, computer software and executable products, application products, design and engineering products, drawings and architectural products, personal histories, employment histories, automotive and other product histories, credit reports, criminal histories, business histories and reports, financial histories and reports, weather reports, scientific reports and findings, regulatory reports and findings and news reports.

5. The method of claims 1, 2, 3 and 4 wherein said insurance may be purchased and/or acquired before, during and/or after the installation or acquiring of games and/or services.

6. An insurance product comprising the method of claim 1.

7. An insurance product comprising the method of claim 2.

8. An insurance product comprising the method of claim 3.

9. An insurance product comprising the method of claim 4.

10. An insurance product comprising the method of claim 5.

11. A method of conducting a business function comprising the method of claim 1.

12. A method of conducting a business function comprising the method of claim 2.

13. A method of conducting a business function comprising the method of claim 3.

14. A method of conducting a business function comprising the method of claim 4.

15. A method of conducting a business function comprising the method of claim 5.
